(19) United States
(12) Patent Application Publication
(10) Pub. No.: US 2021/0355303 A1
(43) Pub. Date: Nov. 18, 2021

(54) A VULCANIZATION MIX, AND IMPLEMENTATIONS THEREOF

(71) Applicant: CEAT LIMITED, MUMBAI (IN)

(72) Inventors: SAMBHU BHADRA, GUJARAT (IN); SUJITH SASIDHARAN NAIR, GUJARAT (IN); NITIN MOHAN, GUJARAT (IN); LAXMI NARASIMHA VENUE GOPAL KRISHNA RAMAVARAPU, GUJARAT (IN)

(21) Appl. No.: 16/617,583

(22) PCT Filed: Jun. 21, 2019
(86) PCT No.: PCT/IN2019/050470

§ 371 Date: Nov. 27, 2019

(30) Foreign Application Priority Data
Jun. 21, 2018 (IN) 201821023285

(51) Int. Cl. C08L 9/06; C08K 5/053; C08K 3/06

(52) U.S. Cl. CPC C08L 9/06; C08K 5/47; C08K 3/06; C08K 5/053

(57) ABSTRACT

A vulcanization mix includes: a) at least one elastomer; b) at least one cross-linking agent; and c) at least one polyol-based accelerator. A vulcanized elastomer can be obtained from the vulcanization mix. A process of preparation of the vulcanization mix and the vulcanized elastomer is also provided.

### TECHNICAL FIELD

The subject matter described herein in general relates to elastomers and in particular relates to materials for improving vulcanization parameters in elastomers.

### BACKGROUND OF INVENTION

Vulcanization of natural latex rubber using sulfur by Charles Goodyear in 1839 revolutionized its applicability. Vulcanization is a process involving thermally treating rubber in the presence of cross-linking agents, such as, Sulfur to obtain more durable forms of rubber. The introduction of 3-dimensional cross-links enables optimum rigidity and makes it easier to process. Over the years, vulcanization process has been revised to comprise a complex number of ingredients such as accelerators for ensuring enhancement of various thermo-mechanical properties.

Vulcanization of rubbers by sulfur alone is an extremely slow and inefficient process. The chemical reaction between sulfur and the rubber hydrocarbon occurs mainly at the C═C (double bonds) and each crosslink requires 40 to 55 sulfur atoms (in the absence of accelerator). The process takes around 6 hours at 140° C. for completion, which is uneconomical by any production standards. The vulcanizates thus produced are extremely prone to oxidative degradation and do not possess adequate mechanical properties for practical rubber applications. These limitations were overcome through the use of accelerators which subsequently have become a part of rubber compounding formulations.

Several broad classes of accelerators, such as, sulfenamides and guanidines are known to provide acceptable reduction in vulcanization or curing times. However, research has been focused on identifying cost-effective alternatives. U.S. Pat. No. 5,354,793 reveals a combination of three accelerators for use along with sulfur for vulcanization. The three identified accelerators are dithiodimorpholine, a dithiocarbamate salt of bismuth and a benzothiazyldisulfide. U.S. Pat. No. 2,091,345 reveals a mercapto benzothiazole as a novel accelerator. There is need in the art to obtain accelerators that are cost effective and also non-corrosive/toxic.

### SUMMARY OF THE INVENTION

In an aspect of the present disclosure, there is provided a vulcanization mix comprising: a) at least one elastomer; b) at least one cross-linking agent; and c) at least one polyol-based accelerator.

In another aspect of the present disclosure, there is provided a vulcanized elastomer obtained from the vulcanization mix comprising: a) at least one elastomer; b) at least one cross-linking agent; and c) at least one polyol-based accelerator.

In yet another aspect of the present disclosure, there is provided a process for preparation of the vulcanization mix comprising: a) at least one elastomer; b) at least one cross-linking agent; and c) at least one polyol-based accelerator, said process comprising: a) obtaining the at least one elastomer; b) obtaining the at least one cross-linking agent; c) obtaining the at least one polyol-based accelerator; and d) contacting the at least one elastomer, at least one cross-linking agent, and at least one polyol-based accelerator to obtain the vulcanization mix.

In yet another aspect of the present disclosure, there is provided a process for preparation of the vulcanized elastomer obtained from the vulcanization mix comprising: a) at least one elastomer; b) at least one cross-linking agent; and c) at least one polyol-based accelerator, said process comprising: obtaining the vulcanization mix by the process comprising: i) obtaining the at least one elastomer; ii) obtaining the at least one cross-linking agent; iii) obtaining the at least one polyol-based accelerator; and iv) contacting the at least one elastomer, at least one cross-linking agent, and at least one polyol-based accelerator to obtain the vulcanization mix; and b) thermally treating the vulcanization mix at a temperature in a range of 80-250° C. to obtain the vulcanized elastomer.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. The same numbers are used throughout the drawings to reference like features and components.

FIG. 1 illustrates the effect of concentration of glycerol on T50, in accordance with an implementation of the present subject matter.

FIG. 2 illustrates the effect of concentration of glycerol on T90, in accordance with an implementation of the present subject matter.

FIG. 3 illustrates rheo-graph for process of vulcanization of the vulcanization mix having varied concentrations of accelerators, in accordance with an implementation of the present subject matter.

FIG. 4 illustrates rheo-graph for process of vulcanization of the vulcanization mix having a combination of glycerol and other accelerator, in accordance with an implementation of the present subject matter.

FIG. 5 illustrates rheo-graph for process of vulcanization of the vulcanization mix having glycerol, in accordance with an implementation of the present subject matter.

FIG. 6 illustrates rheo-graph for process of vulcanization of the vulcanization mix having different polyol-based accelerators, in accordance with an implementation of the present disclosure

FIG. 7 illustrates rheo-graph for process of vulcanization of various vulcanization mix at a temperature of 140° C., in accordance with an implementation of the present disclosure.

FIG. 8 illustrates rheo-graph for process of vulcanization of various vulcanization mix at a temperature of 160° C., in accordance with an implementation of the present disclosure.

FIG. 9 illustrates rheo-graph for process of vulcanization of various vulcanization mix at a temperature of 170° C., in accordance with an implementation of the present disclosure.

FIG. 10 illustrates rheo-graph process of vulcanization of various vulcanization mix for showing mechanism of acceleration provided by glycerol, in accordance with an implementation of the present disclosure.

FIG. 11 illustrates physical appearance of the vulcanization mix with and without the activator and processing aid, in accordance with an implementation of the present disclosure.

### DETAILED DESCRIPTION OF THE INVENTION

Those skilled in the art will be aware that the present disclosure is subject to variations and modifications other than those specifically described. It is to be understood that the present disclosure includes all such variations and modifications. The disclosure also includes all such steps, features, compositions, and compounds referred to or indicated in this specification, individually or collectively, and any and all combinations of any or more of such steps or features.

### Definitions

For convenience, before further description of the present disclosure, certain terms employed in the specification, and examples are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of about 80-250° C. should be interpreted to include not only the explicitly recited limits of about 80° C. to about 250° C., but also to include sub-ranges, such as 80-200° C., 85-250° C., and so forth, as well as individual amounts, including fractional amounts, within the specified ranges, such as 80.2° C., and 240.5° C., for example.

The term “at least one” is used to mean one or more and thus includes individual components as well as mixtures/combinations.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the disclosure, the preferred methods, and materials are now described. All publications mentioned herein are incorporated herein by reference.

The present disclosure is not to be limited in scope by the specific embodiments described herein, which are intended for the purposes of exemplification only. Functionally-equivalent products, compositions, and methods are clearly within the scope of the disclosure, as described herein.

As mentioned previously, there is need for a new accelerator system that is both cost-effective and efficient. The present disclosure provides a vulcanization mix comprising a polyol-based accelerator (such as glycerol) along with a rubber (elastomer) and cross-linking agent that is capable of providing efficient acceleration, i.e., on-par with well-known accelerators, while being economical.

In an embodiment of the present disclosure, there is provided a vulcanization mix comprising: a) at least one elastomer; b) at least one cross-linking agent; and c) at least one polyol-based accelerator.

In an embodiment of the present disclosure, there is provided a vulcanization mix as described herein, wherein the at least one polyol-based accelerator has a concentration in a range of 1-20 phr. In another embodiment of the present disclosure, the at least one polyol-based accelerator has a concentration in a range of 2-20 phr. In another embodiment of the present disclosure, the at least one polyol-based accelerator has a concentration in a range of 2-18 phr. In yet another embodiment of the present disclosure, the at least one polyol-based accelerator has a concentration in a range of 2-15 phr.

In an embodiment of the present disclosure, there is provided a vulcanization mix comprising: a) at least one elastomer; b) at least one cross-linking agent; and c) at least one polyol-based accelerator, wherein the at least one polyol-based accelerator has a concentration in a range of 1-20 phr.

In an embodiment of the present disclosure, there is provided a vulcanization mix as described herein, wherein the at least one polyol-based accelerator has a concentration in a range of 6.5-20 phr. In another embodiment of the present disclosure, the at least one polyol-based accelerator has a concentration range in a range of 7.5-20 phr. In another embodiment of the present disclosure, the at least one polyol-based accelerator has a concentration range in a range of 7.5-18 phr. In another embodiment of the present disclosure, the at least one polyol-based accelerator has a concentration range in a range of 6.5-11 phr. In another embodiment of the present disclosure, the at least one polyol-based accelerator has a concentration of 10 phr.

In an embodiment of the present disclosure, there is provided a vulcanization mix comprising: a) at least one elastomer; b) at least one cross-linking agent; and c) at least one polyol-based accelerator, wherein the at least one polyol-based accelerator has a concentration in a range of 6.5-20 phr.

In an embodiment of the present disclosure, there is provided a vulcanization mix as described herein, wherein the at least one polyol-based accelerator is selected from the group consisting of glycerol, ethylene glycol, propylene glycol, polyethylene glycol, diethylene glycol, triethylene glycol, hexanediol, sorbitol, mannitol, sucrose, catechol, hydroquinone, resorcinol, and combinations thereof. In another embodiment of the present of the present disclosure, the at least one polyol-based accelerator is glycerol,

In an embodiment of the present disclosure, there is provided a vulcanization mix comprising: a) at least one elastomer; b) at least one cross-linking agent; and c) at least one polyol-based accelerator, wherein the at least one polyol-based accelerator is glycerol.

In an embodiment of the present disclosure, there is provided a vulcanization mix comprising: a) at least one elastomer; b) at least one cross-linking agent; and c) at least one polyol-based accelerator, wherein the at least one polyol-based accelerator is glycerol, wherein the glycerol has a concentration in a range of 1-20 phr.

In an embodiment of the present disclosure, there is provided a vulcanization mix comprising: a) at least one elastomer; b) at least one cross-linking agent; and c) at least one polyol-based accelerator, wherein the at least one polyol-based accelerator is glycerol, wherein the glycerol has a concentration in a range of 2-18 phr.

In an embodiment of the present disclosure, there is provided a vulcanization mix comprising: a) at least one elastomer; b) at least one cross-linking agent; and c) at least one polyol-based accelerator, wherein the at least one polyol-based accelerator is glycerol, wherein the glycerol has a concentration in a range of 6.5-20 phr.

In an embodiment of the present disclosure, there is provided a vulcanization mix comprising: a) at least one elastomer; b) at least one cross-linking agent; and c) at least one polyol-based accelerator selected from the group consisting of glycerol, ethylene glycol, propylene glycol, polyethylene glycol, diethylene glycol, triethylene glycol, hexanediol, sorbitol, mannitol, sucrose, catechol, hydroquinone, resorcinol, and combinations thereof.

In an embodiment of the present disclosure, there is provided a vulcanization mix as described herein, wherein the at least one cross-linking agent is selected from the group consisting of sulfur, peroxides, acetoxysilanes, urethanes and metal oxides. In another embodiment of the present disclosure, the at least one cross-linking agent is sulfur.

In an embodiment of the present disclosure, there is provided a vulcanization mix comprising: a) at least one elastomer; b) at least one cross-linking agent; and c) at least one polyol-based accelerator, wherein the at least one cross linking agent is sulfur.

In an embodiment of the present disclosure, there is provided a vulcanization mix comprising: a) at least one elastomer; b) at least one cross-linking agent selected from the group consisting of sulfur, peroxides, acetoxysilanes, urethanes and metal oxides; and c) at least one polyol-based accelerator.

In an embodiment of the present disclosure, there is provided a vulcanization mix as described herein, wherein the at least one elastomer is selected from the group consisting of polybutadiene rubber (BR), styrene-butadiene rubber (SBR), polyisoprene, polychloroprene, hydrogenated nitrile butadiene rubber, ethylene propylene diene monomer rubber (EPDM), and combinations thereof. In another embodiment of the present disclosure, the at least one elastomer is a combination of polybutadiene rubber and styrene-butadiene rubber.

In an embodiment of the present disclosure, there is provided a vulcanization mix comprising: a) at least one elastomer selected from the group consisting of polybutadiene rubber (BR), styrene-butadiene rubber (SBR), polyisoprene, polychloroprene, hydrogenated nitrile butadiene rubber, ethylene propylene diene monomer rubber (EPDM), and combinations thereof; b) at least one cross-linking agent; and c) at least one polyol-based accelerator.

In an embodiment of the present disclosure, there is provided a vulcanization mix as described herein, wherein the at least one cross-linking agent has a concentration in a range of 0.5-3.2 phr. In another embodiment of the present disclosure, the at least one cross-linking agent has a concentration in a range of 0.8-3.0 phr.

In an embodiment of the present disclosure, there is provided a vulcanization mix comprising: a) at least one elastomer; b) at least one cross-linking agent; and c) at least one polyol-based accelerator, wherein the at least one cross-linking agent has a concentration in a range of 0.5-3.2 phr.

In an embodiment of the present disclosure, there is provided a vulcanization mix as described herein, wherein the vulcanization mix optionally comprises at least one other accelerator selected from guanidines, sulfenamides, aldehyde amines, thiazoles, thiophosphates, thiourea, thiuram, dithiocarbamates, xanthates, and combinations thereof. In another embodiment of the present disclosure, the at least one accelerator is a combination of guanidines and sulfenamides.

In an embodiment of the present disclosure, there is provided a vulcanization mix comprising: a) at least one elastomer; b) at least one cross-linking agent; c) at least one polyol-based accelerator; d) at least one other accelerator.

In an embodiment of the present disclosure, there is provided a vulcanization mix as described herein, wherein the at least one other accelerator selected from the group consisting of diphenylguanidine (DPG), N-cyclohexyl-2-benzothiazole sulfenamide (CBS), and combinations thereof. In another embodiment of the present disclosure, the at least one other accelerator is a combination of diphenylguanidine (DPG) and N-cyclohexyl-2-benzothiazole sulfenamide (CBS).

In an embodiment of the present disclosure, there is provided a vulcanization mix comprising: a) at least one elastomer; b) at least one cross-linking agent; c) at least one polyol-based accelerator; and d) at least one other accelerator selected from the group consisting of diphenylguanidine (DPG), N-cyclohexyl-2-benzothiazole sulfenamide (CBS), and combinations thereof.

In an embodiment of the present disclosure, there is provided a vulcanization mix as described herein, wherein the vulcanization mix optionally comprises at least one additive selected from activator, processing aid, antioxidant, filler, or retarder.

In an embodiment of the present disclosure, there is provided a vulcanization mix comprising: a) at least one elastomer; b) at least one cross-linking agent; c) at least one polyol-based accelerator; and d) at least one additive selected from activator, processing aid, antioxidant, filler, or retarder.

In an embodiment of the present disclosure, there is provided a vulcanization mix comprising: a) at least one elastomer; b) at least one cross-linking agent; c) at least one polyol-based accelerator; d) at least one processing aid; and e) at least one filler.

In an embodiment of the present disclosure, there is provided a vulcanization mix as described herein, wherein the activator is zinc oxide and has a concentration in a range of 2-4 phr; the processing aid is selected from the group consisting of steric acid, treated distillate aromatic extracted (TDAE) oil, aromatic oil, paraffinic oil, naphthenic oil, heavy naphthenic oil, spinder oil, residual aromatic extract (RAE), and combinations thereof and has a concentration in a range of 0-30 phr; the antioxidant is selected from the group consisting of N-(1,3-dimethylbutyl)-N′-phenyl-p-phenylenediamine (6PPD), wax, 2,2,4-trimethyl-1,2-dihydroquinoline (TMQ), 1,2-dihydro-2,2,4-trimethylquinoline (TMDQ) and N-isopropyl-N′-phenyl-P-phenylenediamine (IPPD), and combinations thereof and has a concentration in a range of 1-5.5 phr; the filler is selected from the group consisting of carbon black, silica, talc, clay, calcium carbonate, carbon fibre, glass, polyester, polyamide, natural fibers, maize starch, and combinations thereof and has a concentration in a range of 10-200 phr; and the retarder is N-cyclohexylthio-phthalimide (CTP) and has a concentration of 0.1-0.3 phr. In another embodiment of the present disclosure, a coupling agent silane is employed when silica filler is used. In yet another embodiment of the present disclosure a filler employed is silica. In a further embodiment of the present disclosure stearic acid is employed as the processing aid.

In an embodiment of the present disclosure, there is provided a vulcanization mix comprising: a) at least one elastomer; b) at least one cross-linking agent; c) at least one polyol-based accelerator; and d) at least one additive selected from activator, processing aid, antioxidant, or filler, wherein the activator is zinc oxide and has a concentration in a range of 2-4 phr; the processing aid is selected from the group consisting of steric acid, treated distillate aromatic extracted (TDAE) oil, aromatic oil, paraffinic oil, naphthenic oil, heavy naphthenic oil, spinder oil, residual aromatic extract (RAE), and combinations thereof and has a concentration in a range of 0-30 phr; the antioxidant is selected from the group consisting of N-(1,3-dimethylbutyl)-N′-phenyl-p-phenylenediamine (6PPD), wax, 2,2,4-Trimethyl-1,2-Dihydroquinoline (TMQ), 1,2-Dihydro-2,2,4-trimethylquinoline (TMDQ) and N-Isopropyl-N′-Phenyl-P-Phenylenediamine (IPPD), and combinations thereof and has a concentration in a range of 1-5.5 phr; and the filler is selected from the group consisting of carbon black, silica, talc, clay, calcium carbonate, carbon fibre, glass, polyester, polyamide, natural fibers, maize starch, and combinations thereof and has a concentration in a range of 10-200 phr; and the retarder is N-cyclohexylthio-phthalimide (CTP) and has a concentration of 0.1-0.3 phr.

In an embodiment of the present disclosure, there is provided a vulcanized elastomer obtained from the vulcanization mix comprising: a) at least one elastomer; b) at least one cross-linking agent; and c) at least one polyol-based accelerator.

In an embodiment of the present disclosure, there is provided a process for preparation of the vulcanization mix comprising: a) at least one elastomer; b) at least one cross-linking agent; c) at least one polyol-based accelerator, said process comprising: a) obtaining the at least one elastomer; b) obtaining the at least one cross-linking agent; c) obtaining the at least one polyol-based accelerator; and d) contacting the at least one elastomer, at least one cross-linking agent, and at least one polyol-based accelerator to obtain the vulcanization mix.

In an embodiment of the present disclosure, there is provided a process for preparation of the vulcanization mix comprising: a) at least one elastomer; b) at least one cross-linking agent; c) at least one polyol-based accelerator; and d) at least one additive selected from activator, processing aid, antioxidant, or filler, said process comprising: a) obtaining the at least one elastomer; b) obtaining the at least one cross-linking agent; c) obtaining the at least one polyol-based accelerator; d) obtaining the at least one additive; and e) contacting the at least one elastomer, at least one cross-linking agent, and at least one polyol-based accelerator to obtain the vulcanization mix.

In an embodiment of the present disclosure, there is provided a process for preparation of the vulcanized elastomer obtained from the vulcanization mix comprising: a) at least one elastomer; b) at least one cross-linking agent; and c) at least one polyol-based accelerator, said process comprising: a) obtaining the vulcanization mix by the process comprising: i) obtaining the at least one elastomer; ii) obtaining the at least one cross-linking agent; iii) obtaining the at least one polyol-based accelerator; and iv) contacting the at least one elastomer, at least one cross-linking agent, and at least one polyol-based accelerator to obtain the vulcanization mix; and b) thermally treating the vulcanization mix at a temperature in a range of 80-250° C. to obtain the vulcanized elastomer.

In an embodiment of the present disclosure, there is provided a process for preparation of the vulcanized elastomer obtained from the vulcanization mix comprising: a) at least one elastomer; b) at least one cross-linking agent; and c) at least one polyol-based accelerator, said process comprising: a) obtaining the vulcanization mix by the process comprising: i) obtaining the at least one elastomer; ii) obtaining the at least one cross-linking agent; iii) obtaining the at least one polyol-based accelerator; and iv) contacting the at least one elastomer, at least one cross-linking agent, and at least one polyol-based accelerator to obtain the vulcanization mix; and b) thermally treating the vulcanization mix at a temperature in a range of 80-230° C. to obtain the vulcanized elastomer.

In an embodiment of the present disclosure, there is provided a process for preparation of the vulcanized elastomer obtained from the vulcanization mix comprising: a) at least one elastomer; b) at least one cross-linking agent; and c) at least one polyol-based accelerator, said process comprising: a) obtaining the vulcanization mix by the process comprising: i) obtaining the at least one elastomer; ii) obtaining the at least one cross-linking agent; iii) obtaining the at least one polyol-based accelerator; and iv) contacting the at least one elastomer, at least one cross-linking agent, and at least one polyol-based accelerator to obtain the vulcanization mix; and b) thermally treating the vulcanization mix at a temperature in a range of 80-200° C. to obtain the vulcanized elastomer.

In an embodiment of the present disclosure, there is provided a process for preparation of the vulcanized elastomer obtained from the vulcanization mix comprising: a) at least one elastomer; b) at least one cross-linking agent; and c) at least one polyol-based accelerator, said process comprising: a) obtaining the vulcanization mix by the process comprising: i) obtaining the at least one elastomer; ii) obtaining the at least one cross-linking agent; iii) obtaining the at least one polyol-based accelerator; and iv) contacting the at least one elastomer, at least one cross-linking agent, and at least one polyol-based accelerator to obtain the vulcanization mix; and b) thermally treating the vulcanization mix at a temperature in a range of 80-180° C. to obtain the vulcanized elastomer.

In an embodiment of the present disclosure, there is provided a vulcanized elastomer for use in products including not limited to tires, hose, conveyor belt, boat, dock fenders, mats, hot water bags, 0 rings, rail pads, rubber rollers and similar vulcanizable elastomeric products.

Although the subject matter has been described in considerable detail with reference to certain preferred embodiments thereof, other embodiments are possible.

### EXAMPLES

The disclosure will now be illustrated with working examples, which is intended to illustrate the working of disclosure and not intended to take restrictively to imply any limitations on the scope of the present disclosure. Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein. It is to be understood that this disclosure is not limited to particular methods, and experimental conditions described, as such methods and conditions may apply.

The present disclosure provides a vulcanization mix comprising at least one polyol-based accelerator along with a rubber (elastomer) and a cross-linking agent. Polyol, more specifically glycerol was used in sulfur vulcanizable elastomer composition. It acted as an accelerator for sulfur curing/vulcanization of diene elastomers. It was found that glycerol could replace conventional accelerators completely in the vulcanization mix without compromising the kinetics of vulcanization. In fact, Mooney viscosity of the composition containing glycerol was found to be lower, which may give rise to better processing. After addition of glycerol, elongation at break and tear strength of the vulcanized elastomer, were increased without change in tensile strength. Therefore, polyol, more specifically glycerol, was found to be a multifunctional material, which could primarily act as an accelerator for sulfur vulcanization of diene elastomers along with having a secondary functionality contributing towards the enhancement of thermo-mechanical property. This included improvement in processability and increase in elongation at break and tear strength of vulcanized elastomer composition. Moreover, glycerol is environmentally benign (nitrogen and halogen free), a reversion free accelerator (less negative ageing effect) and cost-effective.

### Example 1: Process for Preparation of the Composite

Elastomer was selected containing a diene elastomer, more specifically, a combinations of styrene butadiene elastomer (SBR) and another diene elastomer, butadiene elastomer (BR) was employed. Several additives are usable, i.e., zinc oxide (ZnO) as activator, stearic acid (St-acid) as processing aid, N-(1,3-dimethylbutyl)-N′-phenyl-p-phenylenediamine (6 PPD) and wax as antioxidant, carbon black and silica as filler, silane as coupling agent for silica filler, treated distillate aromatic extracted (TDAE) oil as processing aid, sulphur as crosslinking agent, glycerol, CBS and DPG as other (conventionally known) accelerator and CTP as retarder.

Kobelco intermix, Mixtron BB-L3200 IM, Kobe, Japan was employed to melt and mix the elastomer in the vulcanization mix. A fill factor (FF) of 62% was employed. The mixing was carried out in three steps; (i) preparation of master, (ii) repass, (iii) final mixing with curatives.

Step 1—Preparation of master: At first, all rubbers/elastomers were incorporated and mixed for 45 seconds at a speed of 60 rpm. Then half of all ingredients (except curative system—i.e. sulfur, CBS, DPG and CTB) were incorporated and mixed again for 60 seconds at a speed of 60 rpm. After that, remaining half of the ingredients were incorporated and mixed again for 45 seconds at a speed of 60 rpm. Finally, the mixing was continued for 340 seconds. At this stage, the rpm was varied to maintain the temperature at 150° C.

Step 2—Repass: The master was kept overnight for relaxation. Next day, it was re-mixed for 210 seconds at 70 rpm.

Step 3—Final mixing with curatives: All the master and curatives were incorporated and mixed for 200 seconds to obtain the vulcanization mix. At this stage, the temperature was maintained below 100° C. through rpm control. The vulcanization mix was cured/vulcanized by thermally treating the mix at 160° C. for T₉₀+5 minutes to obtain the vulcanized elastomers (T₉₀ is the time required to complete 90% vulcanization).

### Example 2: Characterization and Testing of the Vulcanized Elastomer

After final mixing, the rheometric tests were performed at 160° C. using Moving Die Rheometer, MDR 3000, MonTech, and Mooney viscosity (ML 1+4) at 100° C. using Mooney Viscometer, and VR-1132, Ueshima, Japan. As mentioned above, the vulcanization mix was cured/vulcanized by thermally treating the mix at 160° C. for T₉₀+5 minutes. Stress vs. strain and tear test was performed using Universal testing machine (UTM), Strograph AE, Toyoseiki and hardness was measured using Durometer, MonTech. A tabulation of the ingredients used and various parameters established are listed below in Table 1.

TABLE 1
Table listing the effect of glycerol concentration
on the properties of the compositions

| | | | | | | |
|---|---|---|---|---|---|---|
| Sample Number | a | b | c | d | e | f |

Step 1: Master

Raw Materials (RM)

| | | | | | | |
|---|---|---|---|---|---|---|
| S-SBR (elastomer) | 70.00 | 70.00 | 70.00 | 70.00 | 70.00 | 70.00 |
| BR (elastomer) | 30.00 | 30.00 | 30.00 | 30.00 | 30.00 | 30.00 |
| ZnO (activator) | 3.00 | 3.00 | 3.00 | 3.00 | 3.00 | 3.00 |
| Steric acid (processing aid) | 2.00 | 2.00 | 2.00 | 2.00 | 2.00 | 2.00 |
| 6 PPD (antioxidant) | 2.50 | 2.50 | 2.50 | 2.50 | 2.50 | 2.50 |
| Wax (antioxidant) | 2.00 | 2.00 | 2.00 | 2.00 | 2.00 | 2.00 |
| Maize starch (filler) | 0.00 | 5.00 | 7.50 | 10.00 | 12.50 | 15.00 |
| Glycerol (accelerator) | 0.00 | 5.00 | 7.50 | 10.00 | 12.50 | 15.00 |
| Carbon black (filler) | 10.00 | 10.00 | 10.00 | 10.00 | 10.00 | 10.00 |
| Silica (filler) | 60.00 | 60.00 | 60.00 | 60.00 | 60.00 | 60.00 |
| Silane (coupling agent for | 9.60 | 9.60 | 9.60 | 9.60 | 9.60 | 9.60 |
| silica) | | | | | | |
| TDAE oil (processing aid) | 20.00 | 20.00 | 20.00 | 20.00 | 20.00 | 20.00 |

Step 2: Repass
Step 3: Final mixing

| | | | | | | |
|---|---|---|---|---|---|---|
| Sulfur | 1.818 | 1.818 | 1.818 | 1.818 | 1.818 | 1.818 |
| CBS | 1.400 | 1.400 | 1.400 | 1.400 | 1.400 | 1.400 |
| DPG | 1.800 | 1.800 | 1.800 | 1.800 | 1.800 | 1.800 |
| CTP | 0.200 | 0.200 | 0.200 | 0.200 | 0.200 | 0.200 |

Properties
RHEOLOGICAL

| | | | | | | |
|---|---|---|---|---|---|---|
| TC 50 (min) | 5.37 | 3.37 | 2.97 | 2.98 | 2.79 | 2.68 |
| TC 90 (min) | 17.57 | 10.10 | 8.71 | 8.48 | 7.61 | 6.51 |
| MH-ML (dN · m) | 21.24 | 20.77 | 20.06 | 19.52 | 18.62 | 17.50 |

STRESS-STRAIN (Cured at T90 time + 5 min)

| | | | | | | |
|---|---|---|---|---|---|---|
| 50% MODULUS (Kg/cm²) | 14.52 | 15.71 | 15.55 | 15.34 | 15.22 | 14.69 |
| 100% MODULUS (Kg/cm²) | 23.06 | 24.59 | 24.46 | 24.21 | 24.2 | 22.42 |
| 200% MODULUS (Kg/cm²) | 50.43 | 51.87 | 51.66 | 50.35 | 50.28 | 43.95 |
| 300% MODULUS (Kg/cm²) | 90.77 | 90.94 | 89.46 | 85.68 | 84.99 | 73.17 |
| 400% MODULUS (Kg/cm²) | 136.91 | 135.34 | 131.91 | 125.65 | 124.5 | 107.7 |
| TENSILE STRENGTH | 177.09 | 181.57 | 185.52 | 189.19 | 176.72 | 176.3 |
| (Kg/cm²) | | | | | | |
| ELONGATION AT BREAK % | 487 | 502.6 | 524.7 | 552 | 528.9 | 580.1 |
| M300%/M50% | 6.25 | 5.78 | 5.75 | 5.58 | 5.58 | 4.98 |
| TENSILE STRENGTH SD | 4.7 | 10.65 | 8.94 | 4.9 | 13.61 | 5.72 |
| HARDNESS SHORE A | 70 | 71 | 71 | 70 | 70 | 69 |

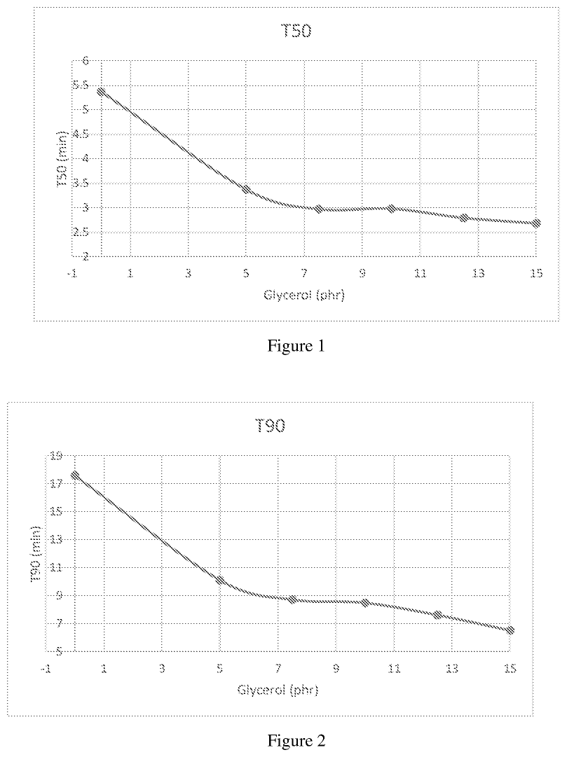

There are many rheological parameters, herein torque with time was tested to identify extent of vulcanization. The green compound/unvulcanized compound (vulcanization mix) was placed in rheometer and heated at 160° C. for certain period of time. During this period crosslinks were formed, and the un-vulcanized compound underwent vulcanization and as a result torque was found to increase. The progress of vulcanization as a function of time and amount of glycerol added was established via the above-mentioned rheological testing (torque versus time). The results are depicted in FIGS. 1 and 2, revealing the T50 and T90 data (T₅₀ and T₉₀ is the time required to complete 50% and 90% vulcanization respectively). The data suggests that upon addition of 5 phr of glycerol, there was a sharp acceleration in curing, however, upon further addition of glycerol, slow acceleration was observed. Additionally, as observed from Table 1, the elastomer containing 10 phr of glycerol (Sample no. d) was found to exhibit high tensile strength (189.19 Kg/cm²) and elongation at break (552%). Overall the elastomer containing 10 phr glycerol was found to perform admirably in terms of mechanical properties. Hence, an attempt was made subsequently to reduce the concentration of conventional accelerators i.e. DPG and CBS, while keeping the amount of glycerol constant, i.e. 10 phr.

Accordingly, the various vulcanized elastomers comprising 10 phr glycerol with reduced amounts of known accelerators are revealed in Table 2 below.

TABLE 2
Table listing progressive replacement of conventional
accelerators (CBS + DPG) with 10 phr of glycerol

| | | | Quantity (phr) | | | |
|---|---|---|---|---|---|---|
| RM type | RM Name | Code | 1 | 2 | 3 | 4 |

Step 1: Mixing of Master

| | | | | | | |
|---|---|---|---|---|---|---|
| Elastomer | S-SBR | R4601 | 70.00 | 70.00 | 70.00 | 70.00 |
| Elastomer | BR | 1678 | 30.00 | 30.00 | 30.00 | 30.00 |
| Activator | ZnO | 135 | 3.00 | 3.00 | 3.00 | 3.00 |
| Activator | St-acid | 224 | 2.00 | 2.00 | 2.00 | 2.00 |
| Antioxidant | 6 PPD | 727 | 2.50 | 2.50 | 2.50 | 2.50 |
| Antioxidant | Wax | 582 | 2.00 | 2.00 | 2.00 | 2.00 |
| Accelerator | Glycerol | | 0.00 | 10.00 | 10.00 | 10.00 |
| Filler | Carbon | N234 | 10.00 | 10.00 | 10.00 | 10.00 |
| | black | | | | | |
| Filler | Silica | 3029 | 60.00 | 60.00 | 60.00 | 60.00 |
| Si coupling | Silane | 6266 | 9.60 | 9.60 | 9.60 | 9.60 |
| Process oil | TDAE oil | 6311 | 20.00 | 10.00 | 10.00 | 10.00 |

Step 2: Repass for viscosity reduction
Step 3: Final mixing with M1

| | | | | | | |
|---|---|---|---|---|---|---|
| Curative | Sulphur | 5299 | 1.818 | 1.818 | 1.818 | 1.818 |
| Conventional | CBS | 327 | 1.400 | 0.560 | 0.280 | 0.140 |
| Accelerator | | | | | | |
| Conventional | DPG | 146 | 1.800 | 0.720 | 0.360 | 0.180 |
| Accelerator | | | | | | |
| (for Si) | | | | | | |
| Retarder | CTP | 774 | 0.200 | 0.200 | 0.200 | 0.200 |
| Accelerator | | | | −60% | −80% | −90% |
| reduction | | | | | | |

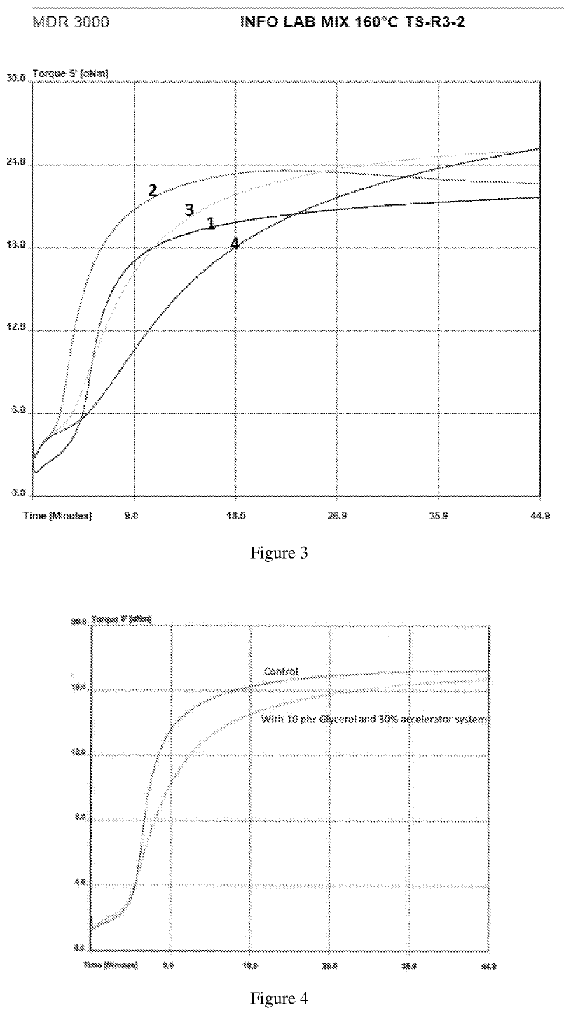

The rheological parameters of the various vulcanized elastomers mentioned in Table 2 above is depicted in FIG. 3. It was observed that with 40% accelerator (60% reduction in conventional accelerator, sample 2) curing was faster and reversion was observed compared to those of control (sample 1). With 20% accelerator (80% reduction in conventional accelerator, sample 3) curing was little slower and curve matched that of control (sample 1). Hence, for detailed study 30% accelerator with 10 phr glycerol was also tested (FIG. 4). The elastomer composition is mentioned in Table 3 below.

TABLE 3
Table listing elastomer comprising 30%
accelerator and 10 phr glycerol.

Sample Number

| | X | Y |
|---|---|---|
| Raw Materials | Quantity (phr) | Quantity (phr) |
| Step 1: Master | | |
| SBR | 70.00 | 70.00 |
| BR | 30.00 | 30.00 |
| ZnO | 3.00 | 3.00 |
| St-acid | 2.00 | 2.00 |
| 6 PPD | 2.50 | 2.50 |
| Wax | 2.00 | 2.00 |
| Carbon black | 10.00 | 10.00 |
| Silica | 60.00 | 60.00 |
| Silane | 9.60 | 9.60 |
| TDAE oil | 20.00 | 20.00 |
| Step 2: Repass | | |
| Step 3: Final mixing with Master | | |
| Sulphur | 1.818 | 1.818 |
| Glycerol | — | 10.00 |
| CBS | 1.400 | 0.420 |
| DPG | 1.800 | 0.540 |
| CTP | 0.200 | 0.200 |

As seen from FIG. 4, the elastomer comprising 30% accelerator (Y) was found to perform comparably with the elastomer vulcanized in presence of conventional accelerators only (X).

The above-mentioned curing curve (FIG. 3) indicated that even a 90% reduction (sample 4) of conventional acceleration system (CBS and DPG) was possible using glycerol. Hence, a 100% replacement of conventional accelerators was attempted. The elastomers tested are mentioned in Table 4 below.

TABLE 4
Table listing elastomers (A) with only sulphur, (B) with sulphur +
Glycerol, and (C) with sulphur + CBS + DPG

| | Sample Number | | |
|---|---|---|---|
| | A | B | C |
| Raw Materials | Quantity (phr) | Quantity (phr) | Quantity (phr) |

Step 1: Master

| | | | |
|---|---|---|---|
| SBR | 70.00 | 70.00 | 70.00 |
| BR | 30.00 | 30.00 | 30.00 |
| ZnO | 3.00 | 3.00 | 3.00 |
| St-acid | 2.00 | 2.00 | 2.00 |
| 6 PPD | 2.50 | 2.50 | 2.50 |
| Wax | 2.00 | 2.00 | 2.00 |
| Carbon black | 10.00 | 10.00 | 10.00 |
| Silica | 60.00 | 60.00 | 60.00 |
| Silane | 9.60 | 9.60 | 9.60 |
| TDAE oil | 20.00 | 20.00 | 20.00 |

Step 2: Repass
Step 3: Final mixing with Master

| | | | |
|---|---|---|---|
| Sulphur | 1.818 | 1.818 | 1.818 |
| Glycerol | — | 10.00 | — |
| CBS | — | — | 1.400 |
| DPG | — | — | 1.800 |
| CTP | 0.200 | 0.200 | 0.200 |

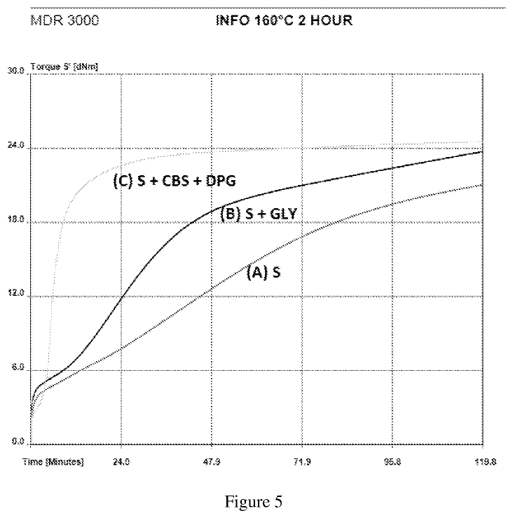

FIG. 5 provides the comparison of the elastomers A, B, and C as mentioned in Table 4 above. The rate of increase of torque value in FIG. 5 indicates the degree of crosslink formation. The cure curve/Rheo curve showed that Sample no. B wherein glycerol could act as accelerator in absence of conventional accelerators. This was supported by the observation that the rate of increase of torque value was higher compared to that of sample no. A wherein only Sulphur was used (absence of any accelerator). Initially, the rate of crosslink formation in the elastomer containing glycerol (B) was less compared to that of CBS+DPG system (C). However, after certain period of time, the torque for both the systems were found to be very close. Thus, indicating that although the rate of acceleration with glycerol was slower, the ultimate crosslink density was expected to be similar to that of CBS+DPG system. Glycerol as accelerator therefore provides slow curing resulting in better scorch safety. As a result, curing of big items (off the road tire, dock fender etc.) wherein slow curing is required to achieve better thermo-mechanical property, can be done using glycerol as accelerator.

### Example 3: Usage of Different Types of Polyols in the Vulcanization Mix for the Preparation of Vulcanized Elastomer and their Rheological Studies

Apart from glycerol different types of polyols were tried as accelerators, such as, polyethylene glycol, sorbitol, mannitol, catechol, ethylene glycol, propylene glycol, triethylene glycol, diethylene glycol and hexane diol (HDP). The conventional combination of CBG+DPG was also tested as control. The rheological parameters of the various vulcanization mixes with different polyols were tested and the results have been depicted in FIG. 6. It is clear from the FIG. 6 that vulcanization mix with glycerol as accelerator was the most effective, while the rest of the polyols as mentioned above, also performed comparably well, in comparison to when no accelerator was used.

### Example 4: Effect of Curing Temperature on Acceleration Effect of Glycerol

Vulcanization temperature has a significant effect on crosslink structure. Optimum properties are obtained when curing is done at the lowest possible temperature. However, to increase productivity, higher temperatures are frequently used. The modulus decreases with increase in cure temperature irrespective of type of accelerator used, which could be recovered to a great extent by increasing dosages of accelerators. Thus, to study the effect of the curing temperature on the acceleration provided by glycerol few experiments were conducted, and rheological studies were carried out for the compositions comprising: i) conventional accelerators [CBS+DPG] only, ii) glycerol only, iii) without any accelerator at different temperatures, i.e., 140° C., 160° C., 170° C.

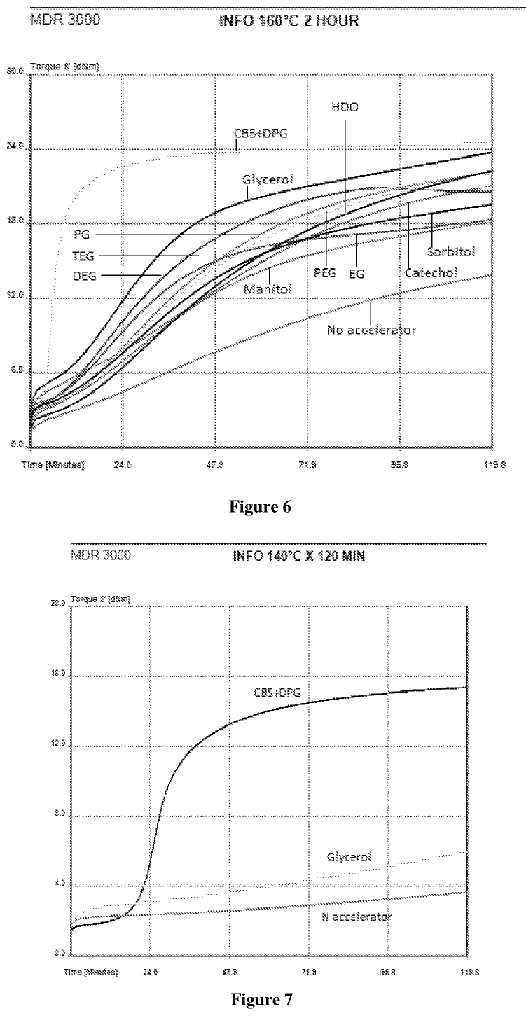

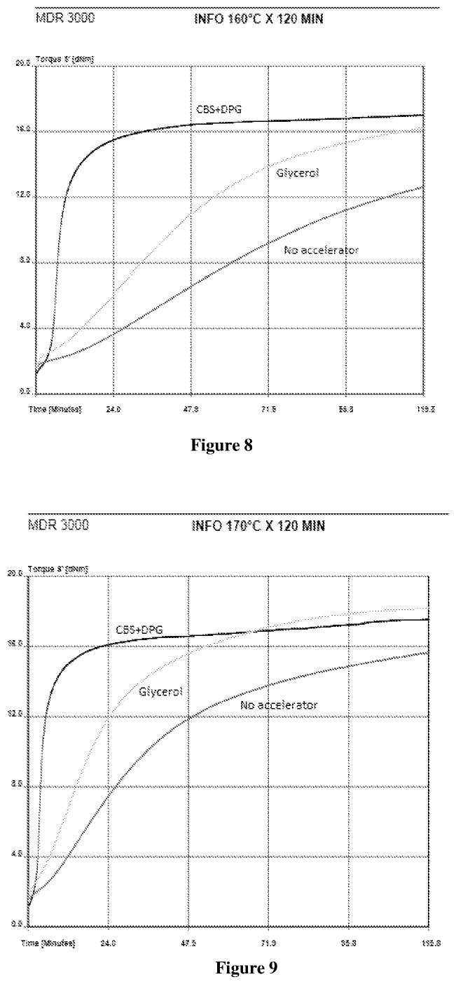

As is clear from FIG. 7, FIG. 8, and FIG. 9, that scorching of rubber composition (vulcanized elastomer thus formed) was observed with traditional accelerator systems, i.e., DPG+CBS at even 125° C. However, when the conventional accelerator system was replaced with glycerol, it is found that the rubber compound was scorch safe even at elevated temperatures between 140° C. to 170° C. Apart from this, glycerol also had a secondary benefit to work as a processing aid. Thus, the vulcanization-mix of the present disclosure comprising at least one polyol, such as glycerol, gave best results even in the temperature range of 140−170° C.

### Example 5: Mechanism of Acceleration by Glycerol

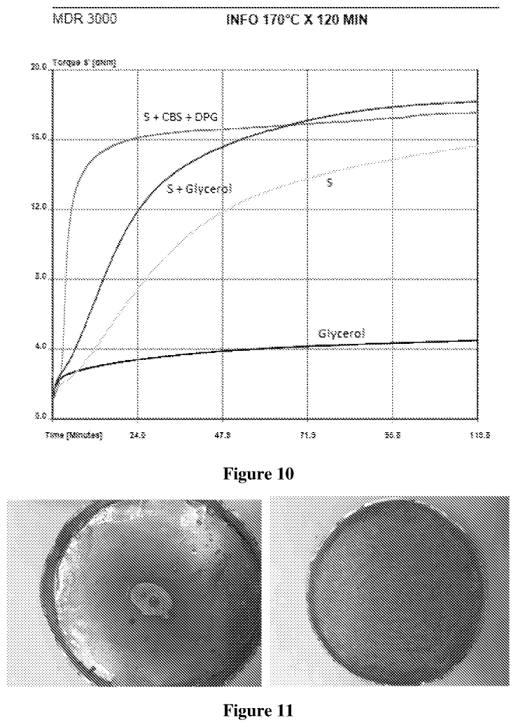

To understand the mechanism of acceleration by glycerol Rheo-test was performed for vulcanization mix with only glycerol (without sulphur and accelerator). From Rheo-curve it appeared that no crosslink formation was observed in case of only glycerol indicating that glycerol itself does not form any crosslink, rather it acts as an accelerator (FIG. 10).

Glycerol exhibited acceleration effect only for diene rubbers with sulphur curing system. When the vulcanization mix was heated beyond 170° C. for 1 hr comprising sulphur and glycerol without using activator, such as zinc oxide and processing aid, such as, stearic acid, it separated out, whereas mixture of sulphur, glycerol, ZnO and Stearic acid after heating at 170° C. for 1 hour formed a paste and after heating formed a single solid (FIG. 11). This fact indicated that, glycerol formed complex (glycerol monostearate) with sulphur, ZnO and stearic acid in a similar manner the other accelerators form complex. The formation of glycerol monostearate was confirmed by characterization through FTIR, NMR, and GC-MS and the same is discussed below.

IR spectra was calculated by Fourier transform infrared spectrophotometer, model—spectrum 100 from Perkin Elmer, USA. In case of pure glycerol a strong and broad peak of —OH stretching vibration was observed at 3323 cm⁻¹ and similarly —OH bending vibration at 1414 cm⁻¹. The absorption peak at 2880 and 2933 cm⁻¹ was due to the C—H stretching vibration of alkane. A strong absorption peak at 1038 and 1110 cm⁻¹ were due to the C—O stretching vibration of primary and secondary alcohol present in glycerol. Some weak peaks were observed between 600-950 cm⁻¹. These were due to the C—H bending vibration of glycerol molecule. In the case of stearic acid, strong absorption peaks at 2917 and 2830 cm⁻¹ were due to the stretching vibration of C—H bonds. An intense peak at 1709 cm⁻¹ was due to the C=0 stretching vibration of the carboxylic group in stearic acid. The peak at 934 cm⁻¹ was due to the out of plane —OH group. From the FT-IR spectrum of the complex it can be concluded that, the absorption peak at 3332 cm⁻¹ was due to —OH stretching vibration of free hydroxyl groups of synthesized GMS (Glycerol mono stearate). A new peak appeared at 1328 cm⁻¹, which was due to the stretching vibration of C—O—C group formed during the esterification reaction of glycerol and stearic acid.

NMR data was obtained from Nuclear Magnetic Resonance Spectrophotometer, Model-Pulsar, Oxford, UK. Glycerol ¹H NMR peaks at 1.51 ppm, 1.87 ppm, 2.48 ppm, 3.74 ppm; Stearic acid ¹H NMR peaks at 0.8-1.0 ppm, 1.2-1.4 ppm and 2.2-2.5 ppm. The down-field chemical shift of δ3.74 ppm was observed due to the presence of tertiary protons (—CH—). The chemical shift of δ2.48 ppm was due to the alcoholic protons of glycerol since they were directly attached to the oxygen atom (—O—H). The up-field chemical shift of δ0.8-1.0 ppm was due to the presence of terminal methyl hydrogen atom (—CH₃). The down-field chemical shift of δ2.2-2.5 ppm was noticed due to the methylene group directly attached to the acid group of the moiety (—CH₂—COOH). A broad peak was observed at a chemical shift between δ1.2-1.4 ppm. This broad peak appeared due to the presence of methylene protons (—CH₂—) in stearic acid. Glycerol-monostearate (GMS) 1H NMR peaks at 0.8-1.0, 1.2-1.4, 1.60, 2.20, 2.35, 3.74, 4.14 and 5.10. The peak at δ0.8-1.0 ppm was due to the presence of terminal methyl hydrogen atom (—CH₃) in stearate moiety. The broad peak between δ1.2-1.4 was due to methylene protons (—CH₂—) in stearic acid. Two overlap peaks at 2.20 and 2.35 ppm were observed due to presence of alcoholic protons of glycerol and methylene protons directly attached to the acid group of the stearate moiety. The down-field chemical shift of δ3.74, 4.14 and 5.0 ppm were observed due to the presence of secondary (—CH₂—) and tertiary protons (—CH—) of glycerol moiety, respectively. These protons exhibited higher chemical shift in 1H NMR spectroscopy. This is due to higher deshielding effect ester and alcoholic group present in the GMS moiety.

GC_MS spectra: Glycerol was observed at a retention time of 15.862 min. The mass spectrometry suggested the formation of three peaks at m/Z values of 93, 75 and 62. The m/Z value at 93 was due to glycerol (C₃H₈O₃ molar mass 92). Stearic acid was observed for the sample at a retention time 18.28 min. The highest m/Z value in the mass spectrometry was found to be 284 for stearic acid (C₁₈H₃₆O₂ molar mass 284). Glycerol monostearate was observed for the sample at a retention time 24.68 min. The mass spectroscopy is given below. The peak at m/Z of 327 was due to the fragmented part of glycerol mono stearate. The strong peak at m/Z value of 267 was observed due to the fragmented part of the stearate moiety.

### Example 6: Lab Trial Data with Passenger Car Radial (PCR) Tread Compound

To evaluate the role of glycerol as accelerator on a real scenario conventional accelerator system (TBBS+DPG) was partially replaced with glycerol in a passenger car radial (PCR) tire tread compound, and tensile strength, elongation at work, tear strength, fatigue to failure were tested and the results are provide in Table 5 below:

TABLE 5

| Formulation | 5 | 6 | 7 | Observations |
|---|---|---|---|---|
| Master | 193.35 | 193.35 | 193.35 | |
| Glycerol | 0.00 | 5.00 | 5.00 | |
| TBBS (732) | 1.70 | 1.06 | 0.53 | |
| DPG (146) | 1.50 | 0.94 | 0.47 | |
| Sulphur (5299) | 2.00 | 2.00 | 2.00 | |

Mooney scorch (ML 5 UP; Minutes)

| | | | |
|---|---|---|---|
| 12.8 | 16.2 | 21.5 | Scorch safety improved with |
| | | | glycerol and reduction of |
| | | | TBBS & DPG |

Stress-strain properties

| | | | | |
|---|---|---|---|---|
| 50% MODULUS | 22.16 | 19.55 | 16.32 | Modulus at 50% strain |
| (Kg/cm²) | | | | decreases with decreasing |
| | | | | TBBS and DPG concentration |
| 300% MODULUS | 0 | 155.65 | 119.76 | Modulus at 300% strain |
| (Kg/cm²) | | | | decreases with decreasing |
| | | | | TBBS and DPG concentration |
| M300%/M50% | 0.000 | 7.962 | 7.338 | Higher the value of |
| | | | | M300%/M50%, better is the |
| | | | | property of vulcanizates. Thus, |
| | | | | Formulation 6 and 7 give the |
| | | | | best results. |
| TENSILE STRENGTH | 163.61 | 187.93 | 215.07 | Tensile strength increased with |
| (Kg/cm²) | | | | glycerol and with reduction of |
| | | | | TBBS and DPG |
| ELONGATION AT | 266.9 | 350 | 469.1 | Elongation at break increased |
| BREAK (%) | | | | with glycerol and reduction of |
| | | | | TBBS and DPG |
| Hardness Shore A | 74.2 | 74.2 | 70.6 | |

Tear Strength

| | | | | |
|---|---|---|---|---|
| ANGLE TEAR | 63.7 | 70.92 | 69.73 | Tear strength increased with |
| STRENGTH (Kg/cm) | | | | glycerol and reduction of |
| | | | | TBBS and DPG |
| EXTENSION (%) | 140.05 | 173.15 | 216.42 | |

Fatigue to failure (FTFT)

| | | | | |
|---|---|---|---|---|
| ORIGINAL 100% | 18 | 278 | 300 | Fatigue to failure property |
| (AVH3) KC * | | | | improved with glycerol and |
| | | | | reduction of TBBS and DPG |
| ORIGINAL 100% | 17 | 276 | 300 | |
| (GMH3) KC** | | | | |
| ORIGINAL 100% | 13 | 216 | 217 | |
| (MEDAIN6) KC*** | | | | |
| S.D**** | 7 | 104 | 111 | |
| HIGH-LOW***** | 57-4 | 300-69 | 300-77 | |

(AVH3) KC *: Average of highest 3 values in Kilocycle (KC).
(GMH3) KC**: Geometric mean of highest 3 values in Kilocycle (KC).
(MEDAIN6) KC***: Median of all 6 values in Kilocycle (KC).
S.D****: Standard deviation
HIGH*****: highest number of cycles required for breaking a test piece
LOW*****: lowest number of cycles required for breaking a test piece of the same sample.

Mooney Scorch: The Mooney scorch time (minutes) was measured until the Mooney viscosity rose 5 points from initial value (ML 5UP). The results are shown in Table 5. The Mooney scorch time is an indicator of scorching (rubber scorching). The longer the time, the result the better. Thus, it is clear that best result was obtained with Formulation 7, wherein the conventional accelerators were replaced with glycerol as shown in Table 5.

According to ASTM D-412, Die type C, the modulus at 100% elongation (M50) (M300), the tensile strength at break at (TB) and the elongation at break (EB) were determined and the results are tabulated in Table 5. With different dosage of accelerator, the tensile strength, and elongation at break was evaluated and it was observed that with increased dosage of glycerol and reduction in dosage of conventional accelerators the tensile strength and elongation at break of the vulcanizates increased. The variation in modulus also showed that the replacement of convention accelerator with glycerol resulted in reduction of cure time. This may be attributed to the reduced accelerator adsorption on the filler surface in the presence of glycerol.

Shore hardness is a measure of the resistance of a material to the penetration of a needle under a defined spring force. It is determined as a number from 0 to 100 on the scales A. The higher the number, the higher the hardness. From Table 5 it is clear that the conventional accelerators can be replaced by glycerol without affecting the properties of the vulcanizates.

Mechanical property such as tear strength was also determined with different dosage of accelerator and it can be inferred from the results obtained that an improved tear strength was achieved due to more uniform distribution of the accelerator system (Table 5).

Failure to fatigue: Total 6 pieces were tested for each compound in Fatigue to failure (FTFT) test. Fatigue to failure in a rubber compound took place when repeated cyclic load or stress is given to a rubber material. Higher value of Fatigue to failure suggested that higher number repeated cyclic loading is required to break the sample. Table 5 suggested that Fatigue to failure property was improved with addition of glycerol and reduction of TBBS+DPG cure system.

### Example 7: Effect of Fillers/Accelerators on the Process of Vulcanization

Vulcanization of rubbers by sulfur alone is an extremely slow and inefficient process. Therefore, various components such as accelerators, fillers are added to the rubber compounds to accelerate the vulcanization process. To understand the role of combination of filler and accelerator on the vulcanization process an experiment was conducted and was observed that vulcanization process was more pronounced, wherein combination of silica and glycerol were used in the rubber compound compared to that of when carbon black was used in rubber compound in place of silica.

It was noted that the combination of silica and glycerol makes the system basic, thereby curing rate increases. Moreover, to understand whether silica is interacting physically or chemically with glycerol, another experiment was performed, wherein silica and glycerol (50:50 w/w) were mixed and heated at 150° C. for 1 hour to allow glycerol to react with silica and form silica-glycerol complex, then excess glycerol was washed with water and finally silica-glycerol solid complex was dried in oven. Then FTIR study was performed for silica, glycerol and silica-glycerol solid complex. Aliphatic alcohol peaks in glycerol, i.e., 1420 cm⁻¹ and 1330 cm⁻¹ and O—H stretching of carboxylic acid in silica, i.e., broad peak between 3300-2500 cm⁻¹ disappeared with the formation of Silica-glycerol solid complex, and a peak at 1738 cm⁻¹ for C═O stretching for ester was observed.

FT-IR results indicated that glycerol forms chemical bonds at higher temperature. Therefore, it can also be used as a silica coupling agent for silica filled rubber compound.

### ADVANTAGES OF THE PRESENT DISCLOSURE

The present disclosure reveals a vulcanization mix comprising a) at least one elastomer; b) at least one cross-linking agent; and c) at least one polyol-based accelerator. The present disclosure also provides convenient processes for preparing the vulcanization mix, as well as the process for preparing the vulcanized elastomer. The incorporation of at least one polyol such as glycerol in the mentioned mix allows complete replacement of expensive conventional accelerators such as DPG and CBS. The vulcanized elastomer obtained by thermally treating the vulcanization mix were found to have improved mechanical properties including tensile strength and elongation at break. Thus, the present disclosure provides a new accelerator for sulphur based vulcanized elastomer, which is nitrogen free, halogen free, reversion free, fossil free material, and scorch safe accelerator. Moreover, it increases tensile strength, elongation at break percentage, tear strength and failure to fatigue.

1. A vulcanization mix comprising:
(a) at least one elastomer;
(b) at least one cross-linking agent; and
(c) at least one polyol-based accelerator.

2. The vulcanization mix as claimed in claim 1, wherein the at least one polyol-based accelerator has a concentration in a range of 1-20 phr.

3. The vulcanization mix as claimed in claim 1, wherein the at least one polyol-based accelerator has a concentration in a range of 6.5-20 phr.

4. The vulcanization mix as claimed in claim 1, wherein the at least one polyol-based accelerator is selected from the group consisting of glycerol, ethylene glycol, propylene glycol, polyethylene glycol, diethylene glycol, triethylene glycol, hexanediol, sorbitol, mannitol, sucrose, catechol, hydroquinone, resorcinol, and combinations thereof.

5. The vulcanization mix as claimed in claim 1, wherein the at least one cross-linking agent is selected from the group consisting of sulfur, peroxides, acetoxysilanes, urethanes and metal oxides.

6. The vulcanization mix as claimed in claim 1, wherein the at least one elastomer is selected from the group consisting of polybutadiene rubber (BR), styrene-butadiene rubber (SBR), polyisoprene, polychloroprene, hydrogenated nitrile butadiene rubber, ethylene propylene diene monomer rubber (EPDM), and combinations thereof.

7. The vulcanization mix as claimed in claim 1, wherein the at least one cross-linking agent has a concentration in a range of 0.5-3.2 phr.

8. The vulcanization mix as claimed in claim 1, wherein the vulcanization mix optionally comprises at least one other accelerator selected from guanidines, sulfenamides, aldehyde amines, thiazoles, thiophosphates, thiourea, thiuram, dithiocarbamates, xanthates, and combinations thereof.

9. The vulcanization mix as claimed in claim 8, wherein the at least one other accelerator selected from the group consisting of diphenylguanidine (DPG), N-cyclohexyl-2-benzothiazole sulfenamide (CBS), and combinations thereof.

10. The vulcanization mix as claimed in claim 1, wherein the vulcanization mix optionally comprises at least one additive selected from activator, processing aid, antioxidant, filler, or retarder.

11. The vulcanization mix as claimed in claim 10, wherein the activator is zinc oxide and has a concentration in a range of 2-4 phr; the processing aid is selected from the group consisting of steric acid, treated distillate aromatic extracted (TDAE) oil, aromatic oil, paraffinic oil, naphthenic oil, heavy naphthenic oil, spinder oil, residual aromatic extract (RAE), and combinations thereof and has a concentration in a range of 0-30 phr; the antioxidant is selected from the group consisting of N-(1,3-dimethylbutyl)-N′-phenyl-p-phenylenediamine (6PPD), wax, 2,2,4-trimethyl-1,2-dihydroquinoline (TMQ), 1,2-dihydro-2,2,4-trimethylquinoline (TMDQ) and N-isopropyl-N′-phenyl-P-phenylenediamine (IPPD), and combinations thereof and has a concentration in a range of 1-5.5 phr; the filler is selected from the group consisting of silica, carbon black, talc, clay, calcium carbonate, carbon fibre, glass, polyester, polyamide, natural fibers, maize starch, and combinations thereof and has a concentration in a range of 10-200 phr; and the retarder is N-cyclohexylthio-phthalimide (CTP) and has a concentration of 0.1-0.3 phr.

12. A vulcanized elastomer obtained from the vulcanization mix as claimed in claim 1.

13. A process for preparation of the vulcanization mix as claimed in claim 1, said process comprising:
a) obtaining the at least one elastomer;
b) obtaining the least one cross-linking agent;
c) obtaining the at least one polyol-based accelerator; and
d) contacting at least one elastomer, at least one cross-linking agent, and at least one polyol-based accelerator to obtain the vulcanization mix.

14. A process for preparation of the vulcanization mix as claimed in claim 10, said process comprising:
a) obtaining the at least one elastomer;
b) obtaining the least one cross-linking agent;
c) obtaining the at least one polyol-based accelerator;
d) obtaining the at least one additive; and
e) contacting at least one elastomer, at least one cross-linking agent, at least one polyol-based accelerator, the at least one additive, and optionally the at least one other accelerator to obtain the vulcanization mix.

15. A process for preparation of the vulcanized elastomer as claimed in claim 12, said process comprising:
a) obtaining the vulcanization mix by the process as claimed in claim 13 or 14; and
b) thermally treating the vulcanization mix at a temperature in a range of 80-250° C. to obtain the vulcanized elastomer.
